(19) United States
(12) Patent Application Publication
(10) Pub. No.: US 2016/0001616 A1
(43) Pub. Date: Jan. 7, 2016

(54) MANIFOLD AND CENTRAL TIRE INFLATION SYSTEM USING THE SAME

(71) Applicant: SHINSEUNG PRECISION INDUSTRY LTD., Changwon-si (KR)

(72) Inventor: Hyun Jung LEE, Changwon-si (KR)

(73) Assignee: SHINSEUNG PRECISION INDUSTRY LTD., Changwon-si (KR)

(21) Appl. No.: 14/470,675

(22) Filed: Aug. 27, 2014

(30) Foreign Application Priority Data
Jul. 3, 2014 (KR) 10-2014-0083261

(51) Int. Cl. B60C 23/16; B60C 23/00

(52) U.S. Cl. CPC B60C 23/16; B60C 23/008

(57) ABSTRACT

Disclosed herein is a manifold for vehicles. The manifold has a rear-wheel air storage space which stores air to be supplied to rear tires, and a front-wheel air storage space which stores air to be supplied to front tires. Each of the air inlet and outlets, which receive external air and discharge air respectively, includes an air flow passage having a tapered shape.

### CROSS-REFERENCE TO RELATED APPLICATIONS

This application claims the benefit of Korean Application No. 10-2014-0083261, filed Jul. 3, 2014, in the Korean Intellectual Property Office. All disclosures of the documents named above are incorporated herein by reference.

### BACKGROUND OF THE INVENTION

1. Field of the Invention

The present invention relates generally to manifolds and CTISs (central tire inflation systems) using the manifolds and, more particularly, to a manifold for CTISs which is configured such that air can be smoothly and reliably injected into tires or discharged therefrom, and to a CTIS using the manifold.

2. Description of the Related Art

Generally, vehicles have wheels and tires. Wheels for a vehicle along with tires support the vehicle and share the entire weight of the vehicle. In addition, wheels are manufactured to withstand the torque generated when braking or driving, impact transmitted from the road, the centrifugal force generated when turning, lateral force applied when the vehicle is tilted, etc. Such a wheel includes a rim, a disk and a hub which is connected to the rim. A tire is provided around the rim.

To enable a wheel to properly conduct its intended function, it is important to optimally maintain the air pressures in tires. Tire pressure is pressure which is applied by air charged into an inner tube of a tire. If tire pressure is excessively low, the durability of the tire is reduced when the vehicle moves at high speed, the rolling resistance of the tire is increased, and the control performance of the vehicle deteriorates. On the other hand, if the tire pressure is higher than the normal, when the vehicle moves at high speed, the vehicle body may wobble considerably despite low impact. Particularly, if the vehicle which has been moving at high speed makes a sudden stop when raining, the risk of an accident greatly increases due to a tire hydroplaning phenomenon.

Therefore, if a vehicle is constantly driven, the pressure in each tire must be checked every day. For typical vehicles which are driven at an ordinary level, conditions of the tires and the tire pressures must be checked about once a month to optimally maintain the tire pressures. When checking the tire pressures, typical users roughly push a tire with his or her hand or foot to determine whether the tire pressures are optimal. This is not an accurate way to measure a tire pressure, and the reliability is low. Thus, it is difficult to accurately determine the tire pressure conditions and whether the tire pressure is optimal or not. Hence, typically, tire pressures of most vehicles must be periodically measured by automobile mechanics, and the operation of charging air into tires must be conducted if the tire pressures are low. This inconveniences users.

FIG. 1 illustrates an example of a CTIS (central tire inflation system). The CTIS is also called a CTI (hereinafter, it will be referred to as a “central tire inflation system” or a “CTIS”). The CTIS uses a fluid pressure source (typically, an air brake compressor or a storage tank), which is generally installed in a vehicle, and remotely controls inflation pressure of at least one tire when the vehicle is stopping and/or moving. The CTIS is a system configured such that, when a vehicle is stopping and when in the case of vehicles with advanced features a vehicle is moving, a driver can remotely manually or automatically control an air system of the vehicle (typically, a truck or the like) to change or maintain the air pressures of one or more tires. In FIG. 1, the dotted line between a control unit 120, an air compressor 110 and a manifold 140 denotes a control signal. The CTIS includes the air compressor 110, an air tank 150, a speed sensing unit 130, the control unit 120, the manifold 140, wheel valves 100a through 100d, a front-wheel air distributor 160a, a rear-wheel air distributor 160b, a display device 170 and an input device 180. The air compressor 110, the air tank 150, the manifold 140, the wheel valves 100a through 100d, the front-wheel air distributor 160a and the rear-wheel air distributor 160b are connected to each other by air horses.

FIG. 2A is a perspective view showing the shape of an air flow passage of a manifold used in a conventional CTIS; and FIG. 2B is a sectional view showing the shape of an air flow passage of a manifold used in a conventional CTIS; and FIG. 2C is a sectional view of external threaded members used in a conventional CTIS. As shown in FIG. 2A, the conventional manifold has a main air flow hole which extends in the longitudinal direction of the manifold, a front-wheel air outlet 23 which is formed at a left end of the main air flow hole, a rear-wheel air outlet 29 which is formed at a right end of the main air flow hole, an air inlet 21 which is formed in a front surface of the manifold and connected to an air tank to receive air from the air tank, and a shut-off outlet 25 and a pressure reducing outlet 27 which are formed in a rear surface of the manifold. However, the manifold 140 having the air flow passage shown in FIGS. 2A and 2B forms an air injection flow in such a way that air injected into the air inlet 21 collides with a portion of the wall of the main air flow passage which faces the air inlet 21, as illustrated by reference numeral 100 of FIG. 2B. As such, the portion of the wall of the main air flow passage which faces the air inlet 21 interrupts the flow of air injected from the air tank 150, thus reducing the flow rate at which air is injected into the manifold. Furthermore, the diameter of the main air flow passage formed in the manifold 140 is constant over the entire length. The length of a path, along which air injected into the main air flow passage of the manifold 140 from the air tank 150 flows to the front-wheel air outlet 23, the rear-wheel air outlet 29, the shut-off outlet 25 or the pressure reducing outlet 27, is comparatively long, thus inducing pressure loss, thereby making it difficult to increase or reduce the tire pressures.

External threaded members are respectively threaded into the air inlet 21, the front-wheel air outlet 23, the rear-wheel air outlet 29, the shut-off outlet 25 and the pressure reducing outlet 27. A tube may be connected to an outer end of each external threaded member. Alternatively, a solenoid valve may be directly connected to each external threaded member. In the conventional technique, each external threaded member (126) must have therein an orifice having a predetermined shape to form optimal air injection pressure or discharge pressure.

For example, an external threaded member (126) is threaded into the air inlet 21 of FIG. 2C. An orifice having a stepped shape is formed in the external threaded member. In this case, air collides with the stepped surface formed in the external threaded member (126). As such, the stepped surface of the orifice disturbs injection or discharge of air. Furthermore, the external threaded member (126), in which an orifice having a stepped shape is formed, is more expensive than an external threaded member having a hole of a constant diameter, thus increasing the production cost of the manifold.

### PRIOR ART DOCUMENT

### Patent Document

(Patent document 1) U.S. Pat. No. 6,083,205 (Registration date: Jul. 4, 2000)

### SUMMARY OF THE INVENTION

Accordingly, the present invention has been made keeping in mind the above problems occurring in the prior art, and an object of the present invention is to provide a manifold and a CTIS using the manifold which is configured in such a way that the structure of airflow impedance is minimized so that air can be smoothly injected from an air tank into the manifold, and in which an air storage space is formed in a main body to store a predetermined volume of air, and air inlet and outlets (an air inlet, a front-wheel air outlet, a rear-wheel air outlet, a shut-off outlet and a pressure reducing outlet) are formed in the main body in such a way that the airflow is smooth.

In order to accomplish the above object, the present invention provides a manifold for supplying compressed air from an air tank to a front tire or a rear tire of a vehicle or discharging air from the front tire or the rear tire of the vehicle to an outside, the manifold including: an air inlet into which compressed air is injected from the air tank; a rear-wheel air outlet through which air is injected into the rear tire of the vehicle or air that has been stored in the rear tire is discharged out of the rear tire; a front-wheel air outlet through which air is injected into the front tire of the vehicle or air stored in the front tire is discharged out of the front tire; a pressure reducing outlet through which air is discharged out of the manifold; a rear-wheel air storage space connected to the rear-wheel air outlet, the rear-wheel air storage space having a predetermined volume to store air therein; a front-wheel air storage space connected to the front-wheel air outlet, the front-wheel air storage space having a predetermined volume to store air therein; and a connection passage formed between the front-wheel air storage space and the rear-wheel air storage space, the connection passage connecting the front-wheel air storage space to the rear-wheel air storage space, wherein the air inlet is connected to the connection passage.

In a manifold and a CTIS using the manifold according to the present invention, a dividing edge part, which is sharp, is formed on a central portion of a wall of a main air flow passage which faces an air inlet. Left and right side surfaces of the dividing edge part are streamlined. Thus, air injected from an air tank into the manifold can be smoothly drawn into a front-wheel air storage space and a rear-wheel air storage space, whereby efficiency of injection of air into the manifold can be enhanced. Furthermore, in the manifold according to the present invention, because the front-wheel air storage space and the rear-wheel air storage space are separately formed in the manifold body, there is the effect of forming an air tank of a small capacity in the manifold body. Therefore, compared to the conventional manifold, the length of the path along which air flows can be reduced. Thus, pressure increasing or reducing air can be supplied to or discharged from the air inlet and outlets.

Moreover, in the manifold and the CTIS using the manifold according to the present invention, each of the air inlet and outlets (an air inlet, a front-wheel air outlet, a rear-wheel air outlet, a shut-off outlet and a pressure reducing outlet) formed in the manifold has a tapered shape configured such that the diameter thereof is reduced in a direction of the flow of air, thus increasing the Bernoulli effect. In addition, the present invention does not use an external threaded member with an orifice having a stepped shape, whereby the flow of air can become smoother, and the production cost of the manifold can be reduced.

Additional aspects and/or advantages of the invention will be set forth in part in the description which follows and, in part, will be obvious from the description, or may be learned by practice of the invention.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a conceptual view of a CTIS;

FIG. 2A is a perspective view and a sectional view showing the shape of an air flow passage of a manifold used in a conventional CTIS; FIG. 2B is a sectional view showing the shape of an air flow passage of a manifold used in a conventional CTIS; and FIG. 2C is a sectional view of external threaded members used in a conventional CTIS;

FIG. 3 is an exploded perspective view of a manifold according to an embodiment of the present invention;

FIG. 4 is a perspective view of an upper manifold body according to the present invention;

FIG. 5A is a plan view of the upper manifold body of FIG. 4; and FIG. 5B is a sectional view showing the coupling of an external threaded member to an air inlet or outlet according to the present invention;

FIG. 6 is a plan view showing an upper surface of an upper manifold body according to another embodiment of the present invention; and

FIG. 7 is an exploded perspective view of a manifold according to a further embodiment of the present invention.

### DETAILED DESCRIPTION OF THE EMBODIMENTS

The present invention will now be described in detail based on embodiments. The present invention may, however, be embodied in many different forms and should not be construed as being limited to only the embodiments set forth herein, but should be construed as covering modifications, equivalents or alternatives falling within ideas and technical scopes of the present invention.

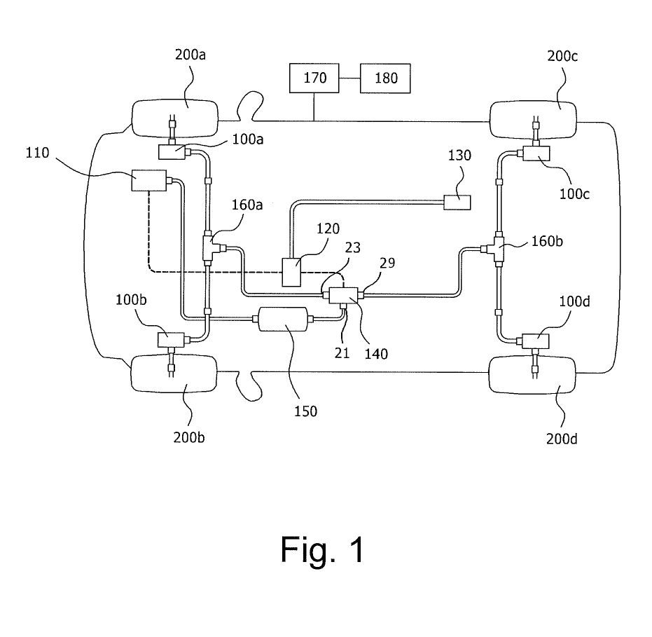

A manifold according to the present invention is one of parts of a CTIS (central tire inflation system) introduced in FIG. 1. The parts of the CTIS introduced in FIG. 1 will be explained in more detail. An air compressor 110 is a device which compresses air from the atmosphere in response to a control signal of a control unit 120. An air tank 150 is a storage vessel for temporarily storing compressed air. Solenoid valves are connected to respective air inlet and outlets formed in the manifold 140. The solenoid valves are controlled in response to a control signal of the control unit 120, thus switching on or off supply of compressed air, whereby compressed air is supplied to a front-wheel air distributor 160a, a rear-wheel air distributor 160b or both the front-wheel air distributor 160a and the rear-wheel air distributor 160b. A pressure sensor is provided in the manifold 140. The pressure sensor can measure the pressure of air stored in the air tank 150 when air is not being supplied to front wheels 200a and 200b or rear wheels 200c and 200d. When, to apply compressed air from the manifold 140 to the front wheels 200a and 200b, the corresponding solenoid valves are controlled, the pressure of air stored in the front wheels 200a and 200b can be measured by the pressure sensor. When, to apply compressed air from the manifold 140 to the rear wheels 200c and 200d, the corresponding solenoid valves are operated, the pressure of air stored in the rear wheels 200c and 200d can be measured by the pressure sensor. Furthermore, the solenoid valves connected to the manifold 140 may be switched such that air is supplied to the front wheels 200a and 200b and the rear wheels 200c and 200d at the same time. In this case, the pressure sensor measures an average tire pressure of the front and rear wheels 200a, 200b, 200c and 200d.

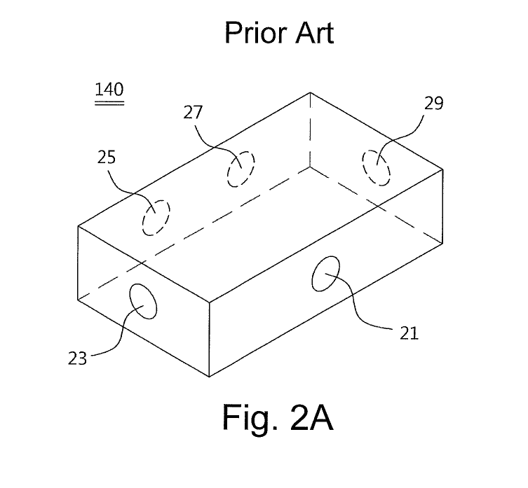

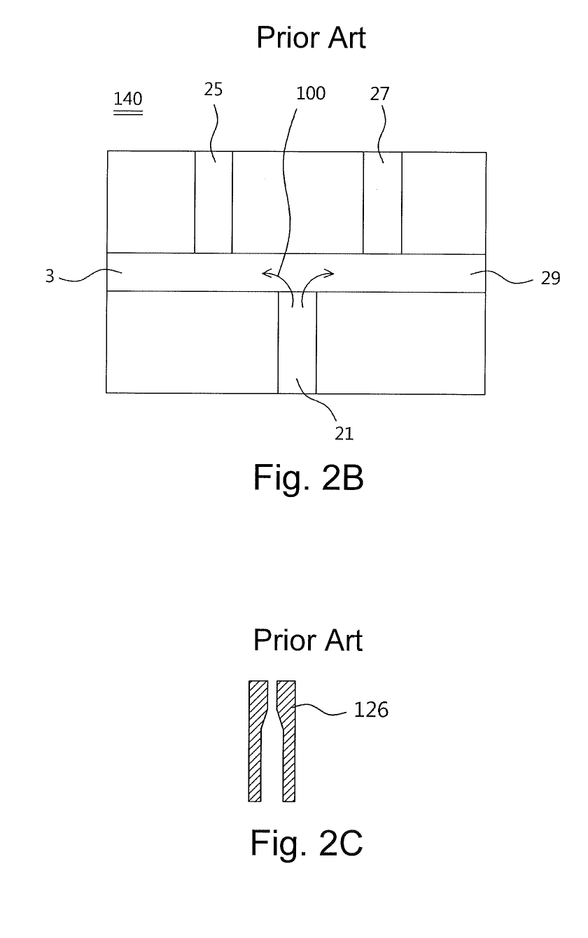

The solenoid valve that is installed on an air inlet 21 of the manifold 140 is connected to the air tank 150 and thus functions to control injection of compressed air from the air tank 150 to the manifold 140. The solenoid valve that is installed on a pressure reducing outlet (27, refer to FIG. 2A) controls the operation in which compressed air is discharged to the atmosphere at a relatively low flow rate so as to reduce the tire pressure. The solenoid valve that is installed on a shut-off outlet (25, refer to FIG. 2A) is used in controlling the operation in which when the tire pressure is set to a desired value, wheel valves 100a through 100d are closed and then compressed air is discharged to the atmosphere at a higher flow rate than that of the pressure reducing outlet 27 so as to maintain the tire air pressure. The solenoid valve that is installed on a front-wheel air outlet (23, refer to FIG. 2A) is used in controlling injection of air into the front tires 200a and 200b. The solenoid valve that is installed on a rear-wheel air outlet (29, refer to FIG. 2A) is used in controlling injection of air into the front tires 200c and 200d.

The front-wheel air distributor 160a functions to distribute compressed air, which is supplied from the manifold 140, to the wheel valves 100a and 100b which are respectively connected to the front wheels 200a and 200b. The rear-wheel air distributor 160b functions to distribute compressed air, which is supplied from the manifold 140, to the wheel valves 100c and 100d which are respectively connected to the rear wheels 200c and 200d. A speed sensing unit 130 senses the speed of a vehicle. A separate sensor may be used as the speed sensing unit 130. However, typically, because measured speed data of a vehicle is stored in a MCU (micro control unit) installed in the vehicle, the speed sensing unit 130 receives the speed of the vehicle from the MCU through CAN (controller area network) communication, which is a kind of serial communication, and then temporarily stores it.

A display device 170 is a device which displays air pressures, applied to the wheels of the vehicle, or setting values, etc. set by a user. The display device 170 can be embodied by a liquid crystal display, an organic electroluminescence display or the like. An input device 180 may includes a touch panel or a remote controller which receives information about vehicle driving conditions from a driver, and an external input terminal which is connected to the control unit 120 and a personal computer (PC) or a vehicle inspection apparatus, which is used by a vehicle maintenance technician such that setting values of tire air pressures can be controlled only by the vehicle maintenance technician, and receives data from the personal computer or the vehicle inspection apparatus.

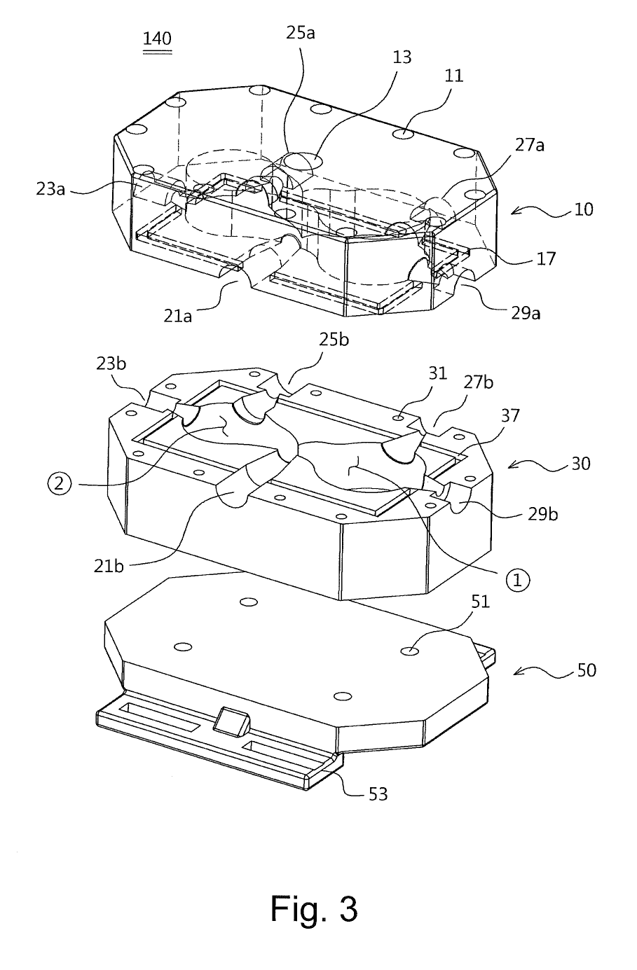

FIG. 3 is an exploded perspective view of a manifold according to an embodiment of the present invention. The manifold according to this embodiment of the present invention includes an upper manifold body 10, a lower manifold body 30 and a manifold bracket unit 50. The upper manifold body 10 and the lower manifold body 30, which are coupled to each other, define therein an air distribution space, which has a rear-wheel air storage space \textcircled{1} and a front-wheel air storage space \textcircled{2}, and form a manifold body which has air inlet and outlets, which communicate with the air distribution space and are exposed to the outside. The manifold bracket unit 50 is coupled to the manifold body by screws and includes brackets 53 for use in mounting the manifold body to the vehicle body. A plurality of first screw passing holes 11 are formed in the perimeter of an upper surface of the upper manifold body 10 at positions spaced apart inwards from the peripheral edge of the upper manifold body 10 in such a way that the first screw passing holes 11 extend from the upper surface of the upper manifold body 10 to a lower surface thereof. A plurality of first screw coupling holes 31, each of which has a predetermined depth, are formed in an upper surface of the lower manifold body 30 at positions corresponding to the respective first screw passing holes 11. The manifold body is assembled by passing screws (not shown) through the respective first screw passing holes 11 and then tightening them into the corresponding first screw coupling holes 31. A plurality of second screw passing holes 51 are formed in the manifold bracket unit 50. A plurality of second screw coupling holes (not shown), each of which has a predetermined depth, are formed in a lower surface of the lower manifold body 30 at positions corresponding to the respective second screw passing holes 51. The manifold bracket unit 50 is coupled to the lower manifold body 30 by inserting screws into the respective second screw passing holes 51 and tightening them into the corresponding second screw coupling holes. The manifold body is attached at a predetermined position to a lower part of the vehicle body by the brackets 53 which are provided on left and right sides of the manifold bracket unit 50.

Protruding downwards, a perimeter protrusion 17 is provided along the perimeter of the lower surface of the upper manifold body 10 around the air distribution space having the rear-wheel air storage space \textcircled{1} and the front-wheel air storage space \textcircled{2}. Having a depth corresponding to the height of the perimeter protrusion 17, a perimeter depression 37 is formed in the upper surface of the lower manifold body 30 at a position corresponding to the perimeter protrusion 17. Thus, when the upper manifold body 10 is coupled to the lower manifold body 30, the perimeter protrusion 17 is inserted into the perimeter depression 37, thus enhancing the airtightness, thereby preventing loss of air. Of course, the design may be modified in such a way that the perimeter protrusion 17 is provided on the upper surface of the lower manifold body 30 while the perimeter depression 37 is formed in the lower surface of the upper manifold body 10. Although it is not shown in FIG. 3, a gasket (not shown) is interposed between the junction surfaces of the upper and lower manifold bodies 10 and 30, thus more reliably preventing loss of air.

A pressure sensor insert hole 13 is formed in a central portion of the upper surface of the upper manifold body 10. The pressure sensor insert hole 13 is a hole which extends from the upper surface of the upper manifold body 10 to the air distribution space. The pressure sensor may be installed in the pressure sensor insert hole 13 with high airtightness therebetween. Alternatively, the pressure sensor may be installed in such a way that a separate external threaded member is airtightly coupled to the pressure sensor insert hole 13 and the pressure sensor is coupled to the external threaded member.

A half of the air distribution space, including the rear-wheel air storage space \textcircled{1} and the front-wheel air storage space \textcircled{2}, is defined by forming an upwardly concave space in the lower surface of the upper manifold body 10. Furthermore, upper air inlet and outlet holes 21a, 23a, 25a, 27a and 29a, which are connected to the half of the air distribution space, are formed in the lower surface of the upper manifold body 10 in such a way that they are exposed to the outside through the outer surface of the upper manifold body 10. A remaining half of the air distribution space, including the rear-wheel air storage space \textcircled{1} and the front-wheel air storage space \textcircled{2}, is defined by forming a downwardly concave space in the upper surface of the lower manifold body 30 which faces the lower surface of the upper manifold body 10. Lower air inlet and outlet holes 21b, 23b, 25b, 27b and 29b, which are connected to the air distribution space, are formed in the in the upper surface of the lower manifold body 30 in such a way that they are exposed to the outside through the outer surface of the upper manifold body 10. That is, the upper manifold body 10 and the lower manifold body 30 are coupled to each other, thus forming the manifold body. The air distribution space, including the rear-wheel air storage space \textcircled{1} and the front-wheel air storage space \textcircled{2}, is formed in the manifold body. Communicating with the air distribution space, the upper and lower air inlet and outlet holes are formed in the manifold body and extended to the outer surface of the manifold body. In more detail, an air inlet (corresponding to 21 of FIG. 2A) is formed by a combination of the upper and lower air inlet holes 21a and 21b. A front-wheel air outlet (corresponding to 23 of FIG. 2A) is formed by a combination of the air inlet-outlet holes 23a and 23b. A shut-off outlet (corresponding to 25 of FIG. 2A) is formed by a combination of the air outlet holes 25a and 25b. A pressure reducing outlet (corresponding to 27 of FIG. 2A) is formed by a combination of the air outlet holes 27a and 27b. A rear-wheel air outlet (corresponding to 29 of FIG. 2A) is formed by a combination of the air inlet-outlet holes 29a and 29b.

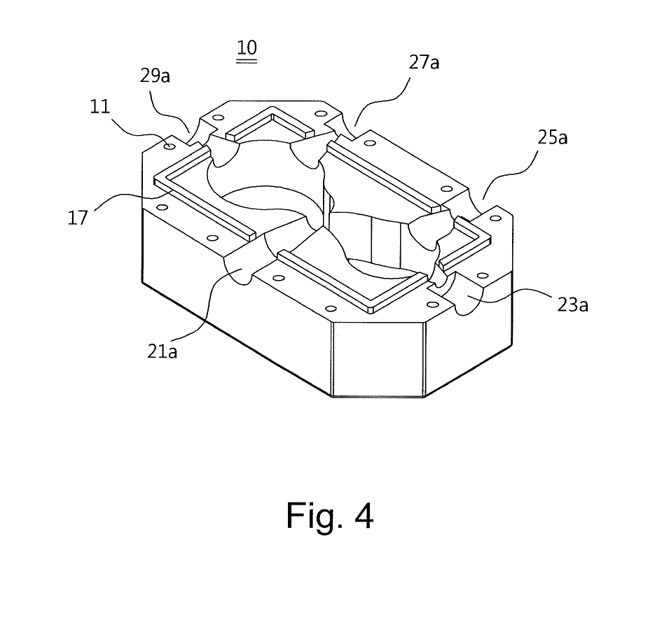

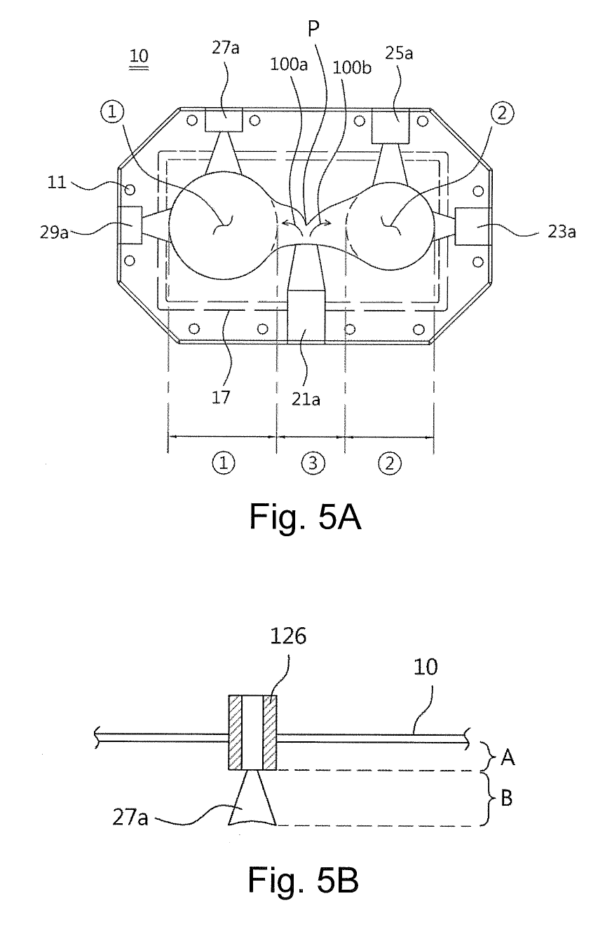

FIG. 4 is a perspective view of an upper manifold body according to the present invention. FIG. 5A is a plan view of the upper manifold body of FIG. 4, and FIG. 5B is a sectional view showing the coupling of an external threaded member to an air inlet or outlet according to the present invention. FIG. 4 shows the upper manifold body which is turned upside down to facilitate understanding the shape of the upper manifold body of FIG. 3. Hereinafter, the structural characteristics of the air distribution space formed in the manifold body according to the present invention will be explained with reference to FIG. 5. The manifold body has therein the rear-wheel air storage space \textcircled{1} formed in a form of a cylinder with a bottom surface having a first radius. The front-wheel air storage space \textcircled{2} formed in a form of a cylinder with a bottom surface having a second radius is defined in the manifold body at a position opposite to the rear-wheel air storage space \textcircled{1} based on the center of the manifold body. The rear-wheel air storage space \textcircled{2} and the front-wheel air storage space \textcircled{2} are connected to each other by a connection passage \textcircled{3}. Here, the first radius is greater than the second radius so that the volume of the rear-wheel air storage space \textcircled{1} is greater than that of the front-wheel air storage space \textcircled{2}. The reason for this is because of the fact that in the case of commercial vehicles such as trucks, the number of rear wheels is typically larger than the number of front wheels, and even if the number of rear wheels is the same as that of the front wheels, higher pressure is applied to the rear tires, so that a larger amount of air must be stored in the rear-wheel air storage space \textcircled{1}.

A dividing edge part P having a sharp shape is provided on a portion of the connection passage \textcircled{3}which is struck by air injected from the air tank through the air inlet 21. By virtue of the dividing edge part P, air supplied through the air inlet 21 can smoothly flow into the rear-wheel air storage space \textcircled{2} along an air path 100a and into the front-wheel air storage space \textcircled{1} along an air path 100b after colliding with the dividing edge part P. The remaining surface of the connection passage \textcircled{3}other than the dividing edge part P has a streamlined shape so that air can be more smoothly supplied into the rear-wheel air storage space \textcircled{1} and the front-wheel air storage space \textcircled{1}.

FIG. 5B is a view showing the section of an external threaded member inserted into the air outlet 27 illustrated in FIG. 5A. Each of the air inlet and outlets of the manifold includes an external threaded member coupling part A which is formed in the outer surface of the manifold, and a tapered part B which extends from the external threaded member coupling part A inwards and forms an air distribution space reduced in diameter from one end thereof to the other end. Inserted into the external threaded member coupling part a, the external threaded member 126 has therein a flow hole having a constant diameter unlike the external threaded member 126 having an orifice shown in FIG. 2C. The reason for this is because the tapered part B is provided in each of the air inlet and outlets of the manifold according to the present invention. The tapered part B formed in each of the air inlet and outlets has a tapered shape, which is reduced in diameter from an air inlet part of the tapered part B to an air outlet part thereof. For example, the air inlet hole 21a connected to the air tank has a tapered shape, which is configured in such a way that the diameter of the air distribution space is reduced from the outside to the inside. Each of the air outlet holes 25a and 27a, which respectively form the shut-off outlet and the pressure reducing outlet, has a tapered shape configured in such a way that the diameter of the air distribution space thereof is reduced from the inside to the outside.

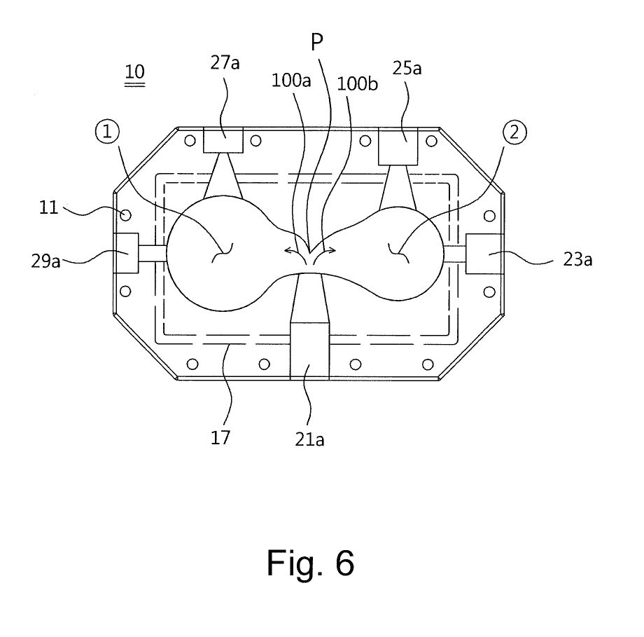

Each of the air inlet-outlet holes 29a and 23a, which respectively form the front-wheel air outlet and the rear-wheel air outlet, may have a linear shape, as shown in FIG. 6, in lieu of a tapered shape, because air bilaterally flows to be drawn into or discharged from the manifold. FIG. 6 is a plan view showing the upper surface of the upper manifold body, corresponding to that of FIG. 5A. FIG. 6 illustrates the air inlet-outlet holes 29a and 23a which do not have a tapered shape. However, generally, the operation of increasing the air pressure of the tires must be more frequently conducted than the operation of reducing the air pressure of the tires. Therefore, as shown in FIG. 5A, it is preferable that each of the air inlet-outlet holes 29a and 23a have a tapered shape configured in such a way that the diameter of the air distribution space is reduced from the inside to the outside.

As shown in FIGS. 3 through 6, the shut-off outlet 25 is configured such that the diameter thereof is greater than the pressure reducing outlet 27 so that after the tire pressures are set as desired values, when the wheel valves 100a through 100d are closed to maintain the tire pressures, compressed air must be discharged to the atmosphere through the shut-off outlet 25 at a higher flow rate than a flow rate of air flowing through the pressure reducing outlet 27.

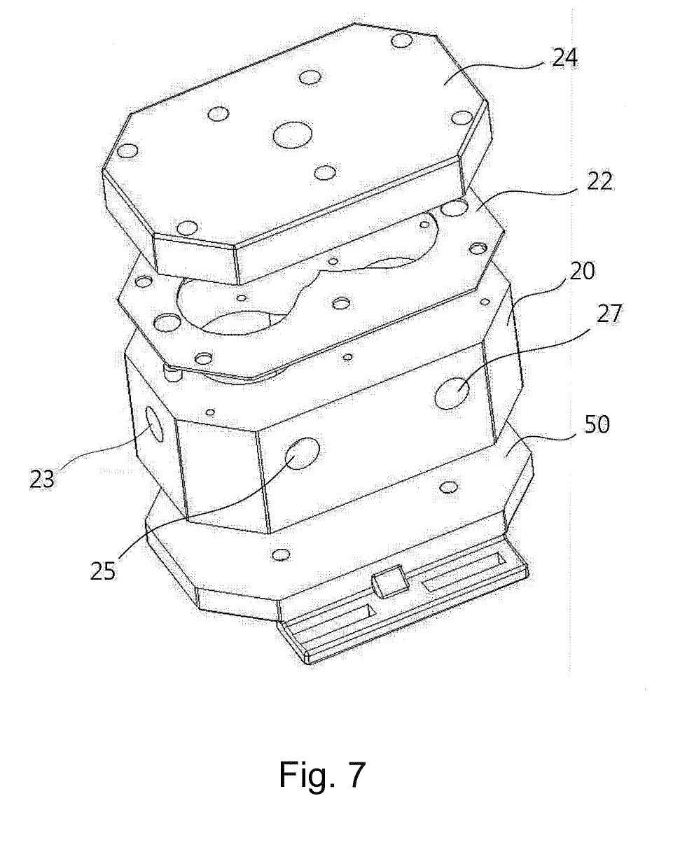

In the above description, the manifold body has been illustrated as being produced by separately manufacturing the upper manifold body 10 and the lower manifold body 30 and then assembling the two bodies 10 and 30 with each other such that the rear-wheel air storage space \textcircled{1}, the front-wheel air storage space \textcircled{2} and the air inlet and outlets are formed in the manifold body. However, although the machinability is comparatively low, the manifold body may be produced in such a way that it is formed into a single integrated body and the rear-wheel air storage space \textcircled{1}, the front-wheel air storage space \textcircled{2} and the air inlet and outlets are formed in the single integrated body. FIG. 7 is an exploded perspective view of a manifold according to another embodiment of the present invention. The manifold introduced in FIG. 7 includes a single integrated manifold body 20, a manifold cover 24, a gasket 22 and a manifold bracket unit 50. In the embodiment of FIG. 7, a rear-wheel air storage space, a front-wheel air storage space and air inlet and outlets are formed in the manifold body 20. The gasket 22 is interposed between the upper surface of the manifold body 20 and the manifold cover 24. The manifold bracket unit 50 is coupled to the lower surface of the manifold body 20 in the same manner as that of the embodiment of FIG. 3. In the embodiment of FIG. 7, because the rear-wheel air storage space, the front-wheel air storage space and the air inlet and outlets must be formed in the integrated manifold body 20, it is difficult to machine the integrated manifold body 20 compared to that of the manifold body of FIG. 3 which is produced by separately manufacturing the upper and lower manifold bodies and then assembling them with each other. However, in terms of airtight performance, the integrated manifold body 20 of FIG. 7 is more advantageous than the manifold body of FIG. 3.

If in the above description of the embodiments, detailed descriptions of well-known functions or configurations would unnecessarily obfuscate the gist of the present invention, the detailed descriptions have been omitted.

It will be understood that, although the terms first, second, etc. may be used herein to describe various elements, these elements should not be limited by these terms. These terms are only used to distinguish one element, from another element. For instance, a first element could be termed a second element without departing from the teachings of the present invention. Similarly, the second element could also be termed the first element. The term “and/or” includes any and all combinations of one or more of the associated listed items.

It will be understood that when an element is referred to as being “coupled” or “connected” to another element, it can be directly coupled or connected to the other element or intervening elements may be present therebetween. In contrast, it should be understood that when an element is referred to as being “directly coupled” or “directly connected” to another element, there are no intervening elements present.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Furthermore, components shown in the embodiments of the present invention are independently shown so as to represent different characteristic functions. Thus, it does not mean that each component forms a constituent unit of separate hardware or one software package. In other words, each component is merely individually illustrated for convenience of explanation. At least two of components may be combined to form one component, or one component may be divided into a plurality of components to perform their functions. Such embodiments where components are combined or one component is divided also fall within the bounds of the present invention if not departing from the essence of the present invention.

Unless otherwise defined, all terms including technical and scientific terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

What is claimed is:

1. A manifold for supplying compressed air from an air tank to a front tire or a rear tire of a vehicle or discharging air from the front tire or the rear tire of the vehicle to an outside, the manifold comprising:
an air inlet into which compressed air is injected from the air tank;
a rear-wheel air outlet through which air is injected into the rear tire of the vehicle or air that has been stored in the rear tire is discharged out of the rear tire;
a front-wheel air outlet through which air is injected into the front tire of the vehicle or air stored in the front tire is discharged out of the front tire;
a pressure reducing outlet through which air is discharged out of the manifold;
a rear-wheel air storage space connected to the rear-wheel air outlet, the rear-wheel air storage space having a predetermined volume to store air therein;
a front-wheel air storage space connected to the front-wheel air outlet, the front-wheel air storage space having a predetermined volume to store air therein; and
a connection passage formed between the front-wheel air storage space and the rear-wheel air storage space, the connection passage connecting the front-wheel air storage space to the rear-wheel air storage space, wherein the air inlet is connected to the connection passage.

2. The manifold as set forth in claim 1, wherein a volume of the rear-wheel air storage space is greater than a volume of the front-wheel air storage space.

3. The manifold as set forth in claim 1, further comprising
a shut-off outlet through which air is discharged out of the manifold at a higher flow rate than a flow rate at which air is discharged out of the manifold through the pressure reducing outlet,
wherein a diameter of the shut-off outlet is greater than a diameter of the pressure reducing outlet.

4. The manifold as set forth in claim 1, wherein a central portion of a surface of the connection passage protrudes towards the air inlet in a form of a sharp edge, the surface of the connection passage being struck by air injected from the air inlet.

5. The manifold as set forth in claim 1, wherein each of the air inlet and the pressure reducing outlet includes: an external threaded member coupling part formed in an outer surface of the manifold; and a tapered part extending from the external threaded member coupling part inwards, the tapered part having a passage reduced in diameter from one end to the other end, wherein the tapered part of the air inlet is configured such that a radius thereof is reduced from the outside to an inside of the manifold, and the tapered part of the pressure reducing outlet is configured such that a radius thereof is reduced from the inside of the manifold to the outside.

6. A central tire inflation system comprising:
the manifold of claim 1; and
the air tank connected to the air inlet of the manifold.
